(19) United States
(12) Patent Application Publication
(10) Pub. No.: US 2004/0083422 A1
(43) Pub. Date: Apr. 29, 2004

(54) System and method for automatically generating patent analysis reports

(76) Inventors: XiuMing Duan, Shenzhen (CN); Caiyang Luo, Shenzhen (CN); Gaopeng Hu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/334,948

(22) Filed: Dec. 31, 2002

(30) Foreign Application Priority Data
Oct. 25, 2002 (TW) 91124864

(51) Int. Cl. G06F 17/00

(52) U.S. Cl. 715/500

(57) ABSTRACT

A system for automatically generating patent analysis reports includes a plurality of client computers (10), an application server (12), and a local database (150). The application server includes a report template maintenance unit (121), a patent downloading unit (120), a patent analysis unit (122), a report generating unit (123), and a controlling unit (124). The local database stores downloaded patents and patent family data. A user sets patent downloading conditions and patent analysis conditions, and selects a patent analysis report template through a user interface (100) of any client computer. The patent downloading unit downloads patents from at least one remote database server (16) according to the patent downloading conditions. The patent analysis unit analyzes corresponding patents according to the patent analysis conditions. The report generating unit generates a patent analysis report according to the selected report template and the analysis results. A method for automatically generating a patent analysis report is also disclosed.

### BACKGROUND OF THE INVENTION

1. Field of the Invention

The present invention relates to a patent information managing system and method, and particularly to a system and method for automatically generating patent analysis reports.

2. Background of the Invention

Patent information includes vast amounts of technological information, legal information, economic information and strategic information. Analysis of patent information can help companies make important strategic decisions. One of the most well known software programs for analyzing patents is SmartPatent Workbench developed by SmartPatents Corporation of the United States. The corresponding patent is U.S. Pat. No. 5,991,751 entitled System, Method, And Computer Program Product For Patent-Centric And Group-Oriented Data Processing, issued on Nov. 23, 1999. The invention discloses a means of combining patent information, financial information, research and development (R&D) information, manufacturing information and licensing information of a company to perform a patent analysis. A patent analysis report mainly analyzes patents in a certain field, and calculates a number of patents according to a particular criterion. Typical criteria include inventors, assignees, patent application dates, patent publication dates, and technological classifications. For instance, the objective of a patent assignee analysis is to calculate a number of patents belonging to each of certain assignees. However, when several similar patent analysis reports need to be generated, users are often required to repeat the same analysis steps. There is a need to provide a system and method for automatically generating patent analysis reports based on analysis conditions set by users, in order to simplify the process of patent analysis.

U.S. Pat. No. 5,189,608, entitled Method And Apparatus For Storing And Generating Financial Information Employing User Specified Input And Output Formats and issued on Feb. 23, 1993, discloses a financial report generating means. The means allows users to define report templates, and can generate financial reports automatically based on the report templates and analysis conditions set by users. However, there is a need to provide a similar means that can be used in patent analysis so as to automatically generate patent analysis reports.

### SUMMARY OF THE INVENTION

Accordingly, a main objective of the present invention is to provide a system and method for automatically generating patent analysis reports according to defined report templates and analysis conditions.

To accomplish the above objective, a system for automatically generating patent analysis reports in accordance with a preferred embodiment of the present invention comprises a plurality of client computers, a local database and an application server. The client computers each include an interactive user interface enabling a user to set patent downloading conditions and patent analysis conditions, and to define and protect patent analysis report templates. The local database stores downloaded patents and patent family data. The application server comprises a report template maintenance unit, a patent downloading unit, a patent analysis unit, a report generating unit and a controlling unit. The report template maintenance unit is for adding, modifying, deleting or searching patent analysis report templates. The patent downloading unit is for automatically downloading patents and patent family data from remote databases according to downloading conditions. The patent analysis unit includes a plurality of patent analysis devices for analyzing patents according to patent analysis conditions, each patent analysis device relating to a particular type of patent analysis. The report generating unit is for automatically generating patent analysis reports according to patent analysis report templates selected by a user and analysis results created in the patent analysis unit. The controlling unit is for controlling operations of said other function units of the application server, and for coordinating interaction between a user and said other function units. The controlling unit accepts patent downloading conditions, transfers the patent downloading conditions to the patent downloading unit, and stores downloaded patents in the local database. The controlling unit also accepts patent analysis conditions, transmits the patent analysis conditions to the patent analysis unit to generate analysis results, transfers the analysis results to the report generating unit, and transmits generated reports to output devices of relevant client computers.

Further, the present invention provides a method for automatically generating a patent analysis report, the method comprising the steps of: (a) setting patent downloading conditions through a user interface; (b) downloading patents from at least one remote database through an external network according to the patent downloading conditions; (c) selecting a report template; (d) selecting at least one type of patent analysis; (e) setting analysis conditions and display formats for analysis results; (f) analyzing patents according to the patent analysis conditions, and translating the analysis results into the display formats selected by the user; and (g) generating a patent analysis report according to the analysis results and the selected report template.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware configuration of a patent analysis report generating system in accordance with a preferred embodiment of the present invention, including a plurality of client computers;

FIG. 2 is a block diagram of main function units of the patent analysis report generating system of FIG. 1, but showing only one of the client computers; and

FIG. 3 is a flowchart of a preferred method for implementing the patent analysis report generating system of the present invention.

### DETAILED DESCRIPTION OF THE INVENTION

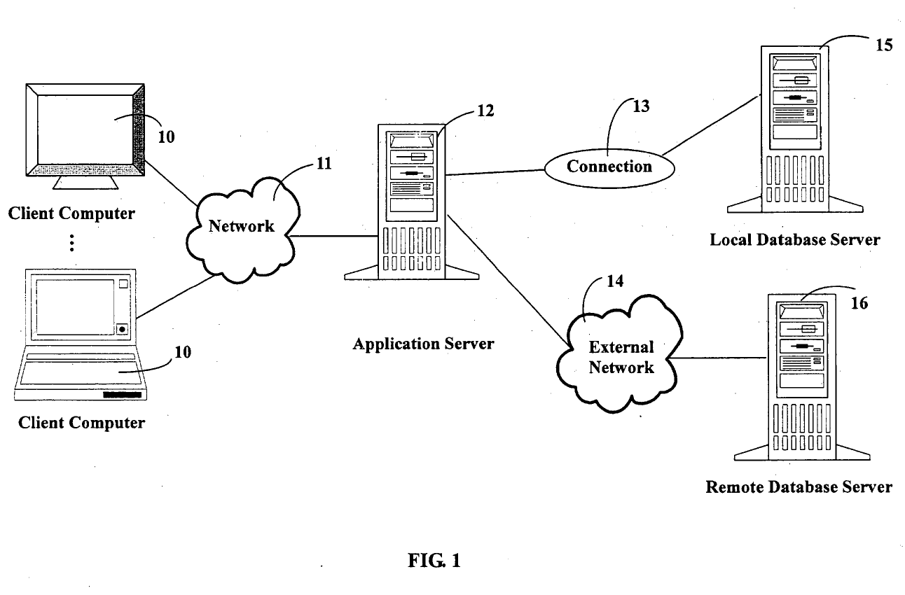

FIG. 1 is a schematic diagram of hardware configuration of a patent analysis report generating system in accordance with a preferred embodiment of the present invention. The system comprises an application server 12, a local database server 15, at least two remote database servers 16 (only one shown), and a plurality of client computers 10 connected to the application server 12 through a network 11. The application server 12 is connected to the local database server 15 through a connection 13, using connectivity such as ODBC (Open Database Connectivity) or JDBC (Java Database Connectivity). Each remote database server 16 is connected to the application server 12 via an external network 14, which may for example be the Internet. The application server 12 accesses patents and patent family data through the remote database servers 16. The local database server 15 stores downloaded patents and patent family data.

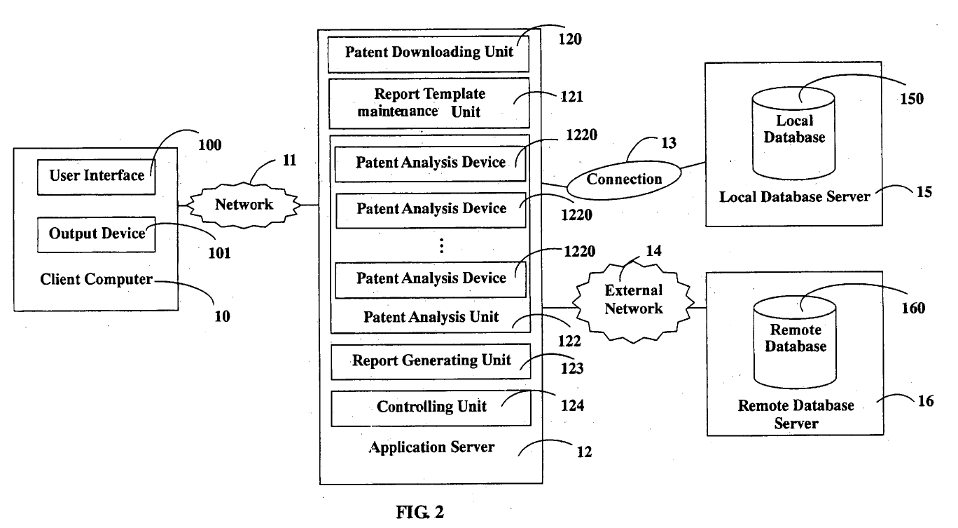

FIG. 2 is a block diagram of main function units of the patent analysis report generating system of FIG. 1, but showing only one of the client computers 10. The client computer 10 comprises a user interface 100 and an output device 101. The user interface 100 is an interactive interface for implementing operations such as defining and protecting patent analysis report templates, setting patent downloading conditions, and setting patent analysis conditions. The output device 101 is used for displaying patent analysis reports.

The application server 12 comprises a patent downloading unit 120, a report template maintenance unit 121, a patent analysis unit 122, a report generating unit 123, and a controlling unit 124. The patent downloading unit 120 downloads patents and patent family data automatically from any remote database server 16. Each remote database server 16 comprises a remote database 160. In the preferred embodiment of the present invention, at least one of the remote database servers 16 is a database of an international patent authority or a government patent office. Such offices may include, for example, the United States Patent and Trademark Office, the European Patent Office and the State Intellectual Property Office of the People's Republic Of China (PRC). Another remote database server 16 is a patent family database such as the database of LexisNexis Corporation. The local database server 15 comprises a local database 150 for storing downloaded patents and patent family data. The patent downloading unit 120 generates queries for searching of patents and patent family data in the respective remote databases 160 according to downloading conditions via the network 14. The search results are transferred to the patent downloading unit 120, and stored in the local database 150 through the connection 13. The downloaded patents are displayed for a user through the user interface 100. Unwanted patents can be deleted from a list of patents stored in the local database 150. The user can also classify the patents through the user interface 100, and store the classifications in the local database 150.

The report template maintenance unit 121 is used for defining and protecting report templates, including adding, modifying, deleting and searching report templates. Defined report templates are stored in the local database 150. Defining a report template includes selecting a document type, a report framework, a report typesetting format, and so on. Patent analysis reports are divided into technology search reports, corporation search reports and product search reports. A technology search report is a type of patent analysis report concentrating on a particular technological field. A corporation search report is a type of patent analysis report concentrating on a particular company. A product search report is a type of patent analysis report concentrating on a particular product. Different patent analysis reports have different report frameworks. For instance, a main body of a technology report may include analysis of application dates or publication dates, patent family analysis, and patent assignee analysis. A main body of a corporation search report may include analysis of application dates or publication dates, patent family analysis, technological area analysis, and patent indicator analysis.

The patent analysis unit 122 comprises a plurality of patent analysis devices 1220 for analyzing patents and patent family data. Each patent analysis device 1220 relates to a particular type of patent analysis. For example, types of patent analysis may include: patent assignee analysis for calculating a number of patents belonging to each of certain assignees; inventor analysis for calculating a number of patents attributable to each of certain inventors; analysis of application dates or publications dates for calculating a number of patents applied for or a number of patents granted in a year; patent attorney analysis for calculating a number of patents obtained by each of certain patent attorneys; patent priority analysis for calculating a number of patents in each priority country or region; technological classification analysis for calculating a number of patents for each of certain technological classifications; examiner analysis for calculating a number of patents checked by each of certain examiners of an international patent authority or a government patent office; patent citation analysis for calculating a number of citations of a patent in subsequently issued patents; patent indicator analysis for calculating patent indicators of a company; and patent family analysis for analyzing distribution patterns of a patent family.

The report generating unit 123 is used for generating patent analysis reports according to analysis results created in the patent analysis unit 122 and report templates selected by the user.

The controlling unit 124 is used for controlling operations of the other function units of the application server 12, and for coordinating interaction between the user and said other function units. The controlling unit 124 accepts patent downloading conditions, transfers the downloading conditions to the patent downloading unit 120, and stores downloaded patents in the local database 150. The controlling unit 124 also accepts patent analysis conditions, transmits the patent analysis conditions to the patent analysis unit 122, transfers analysis results to the report generating unit 123, and transmits generated reports to the output device 101.

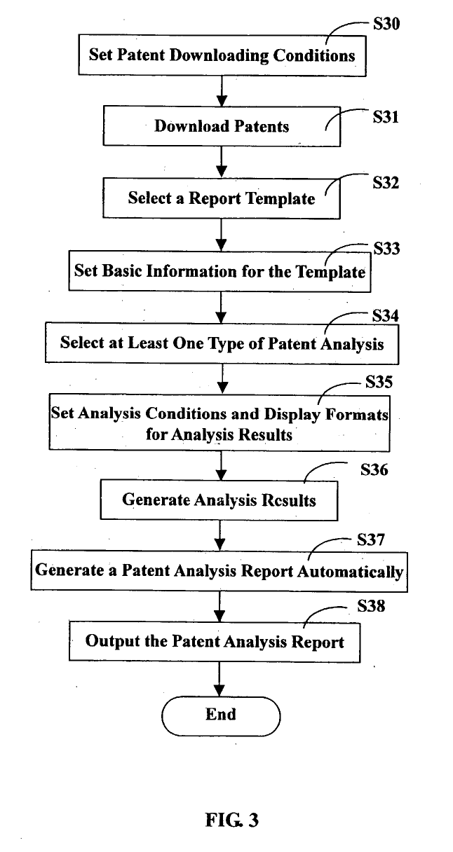

FIG. 3 is a flowchart of a preferred method for implementing the patent analysis report generating system of the present invention.

In step S30, a user sets patent downloading conditions through the user interface 100.

In step S31, the patent downloading conditions are transmitted to the patent downloading unit 120 through the controlling unit 124. The patent downloading unit 120 creates a search sentence according to the patent downloading conditions, and transmits the search sentence to the relevant remote database server 16. The remote database server 16 searches in the remote database 160 for corresponding patents. The search results are returned to the patent downloading unit 120, and are stored in the local database 150 via the controlling unit 124. The user can delete unwanted patents from a patent list displayed on the user interface 100.

In step S32, the user selects a report template.

In step S33, the user sets basic information for the report template, including report title, case number, abstract and person in charge.

In step S34, the report template is transmitted to the report generating unit 123. The user selects at least one patent analysis type. The patent analysis types include patent assignee analysis, inventor analysis, analysis of application dates or publication dates, patent attorney analysis, patent priority analysis, technological classification analysis, censor analysis, patent citation analysis, patent indicator analysis, and patent family analysis.

In step S35, the user sets analysis conditions and display formats for analysis results. For each patent analysis type, there are default analysis conditions and display formats. Setting analysis conditions is done to limit a scope of the patent analysis to a manageable amount of data. For example, setting a fixed time period and/or setting a reasonably narrow classification of technological area can suitably limit the scope of the patent analysis. Setting display formats for analysis results is done to define types of analysis diagrams and formats.

In step S36, the analysis conditions and display formats for analysis results are transmitted to the patent analysis unit 122 through the controlling unit 124. The patent analysis unit 122 starts the corresponding patent analysis device 1220. The patent analysis device 1220 creates a search sentence according to the patent analysis conditions, and transmits the search sentence to the local database server 15. The local database server 15 searches for patents in the local database 150, and generates analysis results.

In step S37, the analysis results are transmitted to the patent analysis device 1220. The patent analysis device 1220 translates the analysis results into the display formats defined by the user. The analysis results are transferred to the report generating unit 123. The report generating unit 123 automatically generates a patent analysis report.

In step S38, the patent analysis report is displayed through the output device 101 of the relevant client computer 10.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for automatically generating patent analysis reports, the system comprising:
a plurality of client computers, each of the client computers comprising an interactive user interface enabling a user to set patent downloading conditions and patent analysis conditions, and to define and protect patent analysis report templates;
a local database for storing downloaded patents and patent family data; and
an application server comprising:
a report template maintenance unit for adding, modifying, deleting or searching patent analysis report templates;
a patent downloading unit for automatically downloading patents and patent family data from at least one remote database according to downloading conditions;
a patent analysis unit including a plurality of patent analysis devices for analyzing patents according to patent analysis conditions, each of the patent analysis devices relating to a particular type of patent analysis;
a report generating unit for automatically generating patent analysis reports according to patent analysis report templates selected by a user and analysis results generated in the patent analysis unit; and
a controlling unit for controlling operations of the report template maintenance unit, the patent downloading unit, the patent analysis unit and the report generating unit, and for coordinating interaction between a user and the report template maintenance unit, the patent downloading unit, the patent analysis unit and the report generating unit.

2. The system according to claim 1, wherein each of the client computers further comprises an output device for displaying patent analysis reports.

3. The system according to claim 1, wherein the types of patent analysis include any one or more of patent assignee analysis, inventor analysis, analysis of application dates or publication dates, patent attorney analysis, patent priority analysis, technological classification analysis, examiner analysis, patent citation analysis, patent indicator analysis and patent family analysis.

4. The system according to claim 1, wherein the client computers are connected to the application server via a network.

5. The system according to claim 1, wherein the application server is connected to the local database through database connectivity.

6. A method for automatically generating a patent analysis report, the method comprising the steps of:
(a) setting at least one patent downloading condition through a user interface;
(b) downloading patents from at least one remote database through an external network according to the at least one patent downloading condition;
(c) selecting a report template;
(d) selecting at least one type of patent analysis;
(e) setting at least one analysis condition and display format for analysis results;
(f) analyzing patents according to the at least one patent analysis condition, and translating the analysis results into the at least one display format selected by the user; and
(g) generating a patent analysis report according to the analysis results and the selected report template.

7. The method according to claim 6, further comprising the step of displaying the patent analysis report to the user through an output device.

8. The method according to claim 6, further comprising any one or more of the steps of searching, adding, modifying and deleting report templates of patent analysis.

9. A method of automatically generating a patent analysis report, comprising steps of:
providing a patent download unit for automatically downloading patents and patent family data from at least one remote database according to download condition set by a user;
providing a local database to store the downloaded data;
providing a report template maintenance unit to define and maintain a plurality of report templates;
selecting at least one of said report templates;
providing a patent analysis unit including a plurality of patent analysis devices each relating to a particular type of patent analysis for analyzing said patents and patent family data;
selecting at least one type of said patent analysis;
setting analysis conditions and display formats for analysis results;
generating said analysis results;
providing a report generating unit; and
automatically generating said patent analysis report according to said analysis results.
